(19) United States
(12) Patent Application Publication
(10) Pub. No.: US 2026/0359396 A1
(43) Pub. Date: Nov. 12, 2026

(54) SYSTEM AND METHODS FOR IMPROVING MACHINE LEARNING DATASETS

(71) Applicant: Open Text Inc., Menlo Park, CA (US)

(72) Inventors: Thomas Sheffield Dalton, San Diego, CA (US); Manish Marwah, Pleasanton, CA (US); Alireza Hadj Khodabakhshi, San Diego, CA (US); Joseph Brett Rombs, Escondido, CA (US)

(21) Appl. No.: 19/673,505

(22) Filed: May 11, 2026

Related U.S. Application Data
(60) Provisional application No. 63/803,691, filed on May 10, 2025.

(51) Int. Cl. G06F 18/214; G06F 16/906; G06F 16/951; G06F 18/22; G06F 18/2413

(52) U.S. Cl. CPC G06F 18/214; G06F 16/906; G06F 16/951; G06F 18/22; G06F 18/24133

(57) ABSTRACT

Embodiments provide systems and methods for enhancing the quality of web-scraped datasets used to train machine learning models, particularly cybersecurity threat detection models for identifying malicious webpages such as phishing pages. Samples are grouped into groups of similar examples using locality-sensitive hashing on vectors derived from webpage HTML content. Groups are processed in descending order of size. A representative prototype is selected from each group and inspected by a human evaluator or evaluation model under a budget constraint. If a prototype is rejected as low-quality, nearest-neighbor samples are identified using a multi-level search based on locality-sensitive hashing buckets and cosine similarity thresholding and removed in bulk along with the prototype. The resulting enhanced dataset is provided for training the machine learning model.

### RELATED APPLICATION(S)

This application claims a benefit of priority under 35 U.S.C. 119 to U.S. Provisional Patent Application Ser. No. 63/803,691 filed May 10, 2025, entitled “SYSTEM AND METHODS FOR IMPROVED MACHINE LEARNING,” which is hereby incorporated herein for all purposes.

### FIELD OF THE INVENTION

Embodiments of the present disclosure relate generally to machine learning and data processing. More particularly, embodiments relate to systems and methods for improving the quality of web-scraped datasets used to train machine learning models, especially models utilized in cybersecurity threat detection.

### BACKGROUND

Machine learning (ML) is emerging as an increasingly important technology in the ongoing battle against cybersecurity threats. Among other applications, ML is used to detect potentially malicious webpages—such as phishing pages—by analyzing patterns in webpage content or metadata, thereby enabling anti-malware systems to block access to pages, issue warnings to users, or take other remedial actions.

The accuracy of a trained ML model depends on the quantity and quality of the training used to build the ML model. Low-quality datasets can degrade ML efficiency by prolonging training times and causing sub-optimal convergence. More critically, low-quality data can actively mislead models into erroneous classifications. ML models used to detect potentially malicious webpages are frequently trained on large-scale datasets of data collected through automated web crawlers and other technologies from tens of thousands or more webpages. Ensuring the quality of such large-scale, web-scraped datasets poses a number of challenges, particularly when malicious content such as phishing sites is encountered. Retrieved content may, for example, differ from intended content due to web host anti-scraping mechanisms, page removals, automatic redirections, or other factors that cause retrieval errors. These errors introduce noise, inaccuracies, and irrelevant content into the training data, degrading downstream learning tasks and the resulting models.

Manual inspection and cleaning of training data used to train threat detection ML models is infeasible. Existing solutions for automated cleaning of web-scraped data are limited to simple filtering, such as filtering to remove samples that represent non-200 OK HTTP status codes. But a 200 OK HTTP status code does not necessarily imply that the page was successfully crawled as expected. Thus, such filtering methods fail to filter out a large volume of low-quality data.

What is desired then are enhanced techniques to improve machine learning by improving the quality of data in an automated or semi-automated fashion.

### SUMMARY

Embodiments of the present disclosure provide systems and methods for enhancing the quality of web-scraped datasets for machine learning models. In particular, embodiments address the challenges associated with collecting webpage data at scale when malicious content such as phishing sites is encountered. Web-scraped datasets frequently contain substantial amounts of low-quality data resulting from multiple failure modes, including failures due to cloaking/anti-bot measures and failures due to ephemerality. These failures introduce noise, inaccuracies, and irrelevant content that can degrade machine learning efficiency and cause model poisoning.

According to one embodiment, a data enhancement service accesses an initial web-scraped dataset and performs an initial filtering step. Samples are then grouped into groups of similar examples using locality-sensitive hashing or other grouping techniques. Prototypes are selected from the groups, with groups processed in descending order of size so that the most common failure modes are addressed first. Each prototype is inspected by a human evaluator or by an evaluation model under a budget constraint to determine whether it represents low-quality data. If a prototype is rejected, nearest-neighbor samples are identified using an efficient multi-level search and removed in bulk along with the rejected prototype. The resulting enhanced dataset is provided to a machine learning training stage, thereby improving the accuracy and reliability of threat-detection models.

Embodiments described herein provide significant advantages over purely manual cleansing methods and over simple HTTP-status-code filtering by efficiently removing large classes of problematic samples while requiring inspection of only a small number of representative prototypes.

### BRIEF DESCRIPTION OF DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like-reference numbers indicate like features.

FIG. 1 is a diagrammatic representation of one embodiment of a system for protecting computers from malicious content.

FIG. 2 is a diagrammatic representation of another embodiment of a system for protecting computers from malicious content.

FIG. 3 is a flowchart illustrating one embodiment of a method for enhancing a dataset for machine learning.

FIG. 4 depicts pseudocode for one embodiment of grouping samples into buckets of similar examples.

FIG. 5 depicts pseudocode for one embodiment of prototype selection and inspection.

FIG. 6 depicts pseudocode for one embodiment of performing an efficient near neighbor search.

FIG. 7 depicts pseudocode for one embodiment of removing samples from the web dataset.

FIG. 8 depicts pseudocode for enhancing data according to another embodiment.

FIG. 9 is a diagrammatic representation of one embodiment of a computer environment.

### WRITTEN DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments of the subject disclosure provide efficient, computer-implemented techniques that enhance the quality of datasets to improve the reliability and effectiveness of the machine learning (ML) learning tasks and increase the accuracy of resulting ML models trained on the web datasets. The enhancement in dataset quality is achieved using an efficient filtering process wherein whole groups of problematic data are removed from the web dataset at a time, leaving only high-quality examples remaining. Because only a few representative samples (i.e. prototypes) are individually inspected, the web dataset cleaning task is streamlined. This approach offers a significant advantage over purely manual cleansing methods by markedly reducing human effort and associated costs. Furthermore, embodiments described herein provide advantages over automated methods that filter based solely on HTTP status code by filtering out low-quality data, even when the low-quality data represents a response to a successful request (e.g., even when the data represents a 200 OK HTTP status code).

An ML model may be trained using a dataset in which individual instances (observations/examples) representing categories relevant to training the ML model are encoded as corresponding data points. To this end, an initial dataset comprising representative samples for target categories is collected or accessed. In a dataset for training an ML model to classify webpages, the samples (data points) may represent webpages belonging to the categories on which an ML model is to be trained.

An individual sample (data point) may comprise a collection of features that describes a corresponding instance. A sample (data point) representing a webpage may, for example, include webpage data from or about the corresponding webpage, such as HTML scraped from the webpage, metadata about the webpage or other data related to the webpage. In an even more particular embodiment, a data point representing a webpage comprises a string containing HTML content from the scraped webpage. The samples in the web dataset are represented as corresponding data structures (e.g., records, vectors) encoding features in a format suitable for processing by a computer.

Thus, the initial dataset may include web-scraped data in some embodiments. There are, however, a number of failure modes that can lead to low quality data when scraping web pages. These failure modes can be broadly classified as failures due to cloaking/anti-bot technology and failures due to ephemerality. Examples of failures due to cloaking/anti-bot technology include failures due to IP restrictions, browser/user-agent fingerprinting, geographic targeting, and time-delayed presentation.

With IP restrictions, a page is presented only to clients originating from a specific list of IP addresses (i.e., the client IP address is whitelisted). Examples include spear phishing attacks which target a specific organization or group. In another form of IP restricting, the page is blocked if the client IP address originates from a list of IP addresses (i.e., the client IP address is blacklisted). For example, to evade detection, a phisher may block any clients with an Amazon Web Services (AWS) IP address, or an IP address known to belong to a security firm.

Turning to browser/user-agent fingerprinting, web browsers present certain fingerprint information which the server can use as a basis to reject or accept incoming requests. For example, a page may be presented to the client only if it appears to be a mobile web browser as opposed to, say, a desktop browser.

With respect to geographic targeting, phishing campaigns are often targeted or relevant to specific geographic regions. For example, a phishing page may target a Japanese bank and thus only be presented to Japanese clients. This geographic targeting can be accomplished by way of IP restriction, user-agent fingerprinting, a combination thereof, or other methods.

With time delayed presentation, the web host presents some non-phishing content (say, a loading page bar, for example) for some short duration then replaces the loading page with the actual malicious content.

Moreover, malicious pages are frequently ephemeral-sometimes lasting only a few minutes before going offline.

Multiple failure modes are frequently encountered when scraping phishing pages. For example, DNS resolutions issues can prevent pages from being scraped, security takedown notices can prevent pages from being scraped, URL shortening services can block access to intended pages, redirects to legitimate pages can result in mislabeled data, etc.

Any one of the failure modes described above can result in data quality issues. In these scenarios, it is often the case that the page that was scraped was not the intended target. Moreover, web hosts often replace the content of phishing pages with takedown notices which results in many data points including HTML content that are nearly (or exactly) identical and of little value in training.

In more sophisticated attacks, a malicious web host may detect that it is being scraped and redirect the crawler to the legitimate counterpart webpage instead of its own illegitimate page. Here, the collected page becomes actively harmful (as opposed to merely just noise), since a benign target page may be labeled as malicious (e.g., based on the URL being labeled as malicious), to downstream models trained on such datasets.

Because pages are scraped in an automated fashion, the various types of failure modes detailed above can be difficult to detect and address. Embodiments of the present disclosure, however, provide automated and computer-assisted techniques to identify and remove low-quality data points resulting from such failure modes. Embodiments described herein may also be applied to other types of training datasets including datasets that do not include web-scraped data.

In a prototype discovery phase, samples from the initial dataset are grouped into groups of similar samples. Groups may be formed using a variety of techniques, such as, but not limited to: clustering methods, such as k-means, hierarchical clustering, or other clustering techniques; fuzzy hashing methods such as locality-sensitive hashing or other fuzzing hashing techniques; or anomaly detection. Samples may also be grouped together using various heuristics and/or characteristics of the data points, such as page title or domain name.

Representative examples (referred to as prototypes) are selected from the groups for further evaluation. Prototypes may be selected according to a variety of techniques, such as via simple random sampling or by choosing the group “average.” In cases where clustering is used for group formation, the centroid of the cluster can be determined and the member sample that is closest to the centroid can be selected as the “average member” of the group. Likewise, in cases where fuzzy hashing forms the basis for groups, the centroid of a bin can be calculated from all the members within the bin and the member sample closest to the bin centroid selected as the “average member.” As another example, the group medoid can be selected as the prototype for the group.

The prototypes may be assessed for quality to determine whether to keep or reject the prototypes for the final dataset. This evaluation process may be a human-in-the-loop process in which the prototypes are provided to a human evaluator for review. Based on interaction with a graphic user interface or other interface, the human evaluator can indicate whether to keep or reject selected prototypes. In other embodiments, an evaluation model is applied to the selected prototypes. The evaluation model may be a rule-based model or a machine learning model, such as a neural network, that is trained using samples to categorize new samples based on quality. For example, an ML evaluation model may be trained using low quality samples and high-quality samples to categorize prototypes according to corresponding categories, such as “keep” or “reject.”

It may be desirable, in some embodiments, to limit the number of evaluations performed. As such a budget may be imposed on the evaluation such that the number of prototypes evaluated is limited by the budget. Thus, for example, evaluators may evaluate a number of prototypes in priority order until the budget is exhausted.

According to one embodiment, an efficient near-neighbor search is performed to find other samples that are similar to rejected prototypes. These samples may also be rejected from inclusion in the enhanced dataset. Various methods for determining near-neighbor samples may be used. One embodiment of an efficient near-neighbor search uses locality-sensitive hashing. In another embodiment, a linear search is performed to find the near neighbor samples near to a rejected prototype.

In some embodiments, a multi-level search is performed. In one embodiment of a multi-level search, a first search level returns the samples from nearby groups that are sufficiently near to the group from which the rejected prototype was selected. To this end, a nearby group search may be performed to identify the nearby groups. In one embodiment, the groups that have a Hamming distance less than a threshold h from the prototype's group are identified as nearby groups.

According to one embodiment, the other samples in the rejected prototype source group (that is, the group from which the prototype was selected) and the samples from the nearby groups are identified as candidate samples. A second search level finds candidate samples that are sufficiently similar to the rejected prototype. Candidate samples that are sufficiently close to the rejected prototype may be identified as low-quality samples. According to one embodiment, the cosine distance between the prototype sample and each candidate sample is determined. A cosine similarity threshold t can be used to eliminate erroneous “bad” collision data points so that only true near neighbors are returned as near neighbors to be removed.

The rejected prototypes and nearest neighbor samples can be removed from the web dataset to generate an enhanced training dataset.

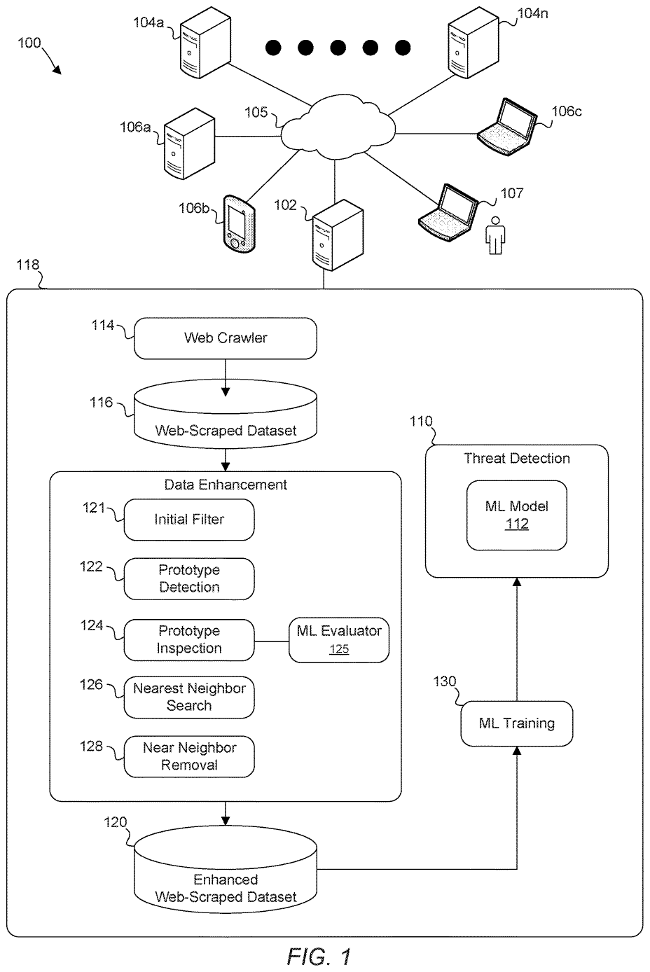

FIG. 1 is a diagrammatic representation of one embodiment of a system 100 for protecting computers from malicious content. System 100 includes a threat detection system 102 coupled to various web site servers (e.g., server 104a through 104n), threat detection client computers (e.g., client computer 106a, client computer 106b, client computer 106c are illustrated) and reviewer computers (e.g., reviewer computer 107), which may also be threat detection client computers, via network 105, which may include a combination of networks. Network 105 may include local area networks, wide area networks, such as the Internet, or other networks.

Threat detection system 102 comprises one or more servers providing threat detection related services. In particular, threat detection system 102 includes a threat detection engine 110 that uses ML model 112 to classify content into one or more groups or categories (e.g., malicious, suspicious, safe, unknown, etc.). According to one embodiment, ML model 112 may be trained to classify webpages as “phishing” or “benign.” ML model 112 may be a predictive or statistical machine learning component that may be used to determine a probability distribution over one or more character sequences, classes, objects, result sets or events, and/or to predict a response value from one or more predictors. In some embodiments, ML model 112 comprises a neural network. ML model 112 can comprise multiple models working as an ensemble using multiple detection approaches.

Threat detection client devices 106a-106c may submit data, such as resource identifiers (e.g., URLs), for evaluation by threat detection system 102. In aspects, resource identifiers, such as URLs, received from client devices 106a-106c may be made accessible to a content searching utility or service, such as web crawler 114. Web crawler 114 may scrape content from the target pages (or other resources) referenced by the resource identifiers. Scraped content can be provided to threat detection engine 110 to determine if a provided resource identifier represents a malicious webpage. Threat detection engine 110 uses ML model 112 to evaluate content scraped from the web pages associated with resource identifiers to classify the resource identifiers (e.g., URLs) into categories (e.g., phishing, benign, etc.). If a resource identifier is classified as malicious (e.g., “phishing”), threat detection engine 110 may take remedial action, such as sending a message to the client computer to block downloading of a resource, sending a hyperlink referencing a security patch for securing the vulnerabilities exploitable by the malicious URL, etc.

ML model 112 may be trained on a dataset that includes content scraped from web pages. To this end, threat detection system 102 includes a web-scraped dataset 116 in which the samples (data points) represent webpages belonging to the categories on which ML model 112 is to be trained. Each sample (data point) may represent a corresponding webpage instance and include webpage data from or about the corresponding webpage, including HTML scraped from the webpage. A sample may also include webpage metadata or other information from or about the corresponding webpage. In an even more particular embodiment, each data point comprises a string containing HTML content scraped from a corresponding webpage. In some embodiments, the samples in the web dataset are represented as corresponding records or vectors encoding features in a format suitable for processing by a computer. Web-scraped dataset 116 may include tens-of-thousands or more (e.g., hundreds of thousands or millions) samples. In one embodiment, web-scraped dataset 116 includes collected data for over one hundred thousand phishing pages and over two hundred thousand benign pages.

In some cases, a portion of web-scraped dataset 116 may be provided by a third party. For example, commercial and volunteer threat detection providers publish web-scraped datasets. In addition, or in the alternative, threat detection system 102 may collect its own web-scraped dataset. For example, various commercial and volunteer threat detection providers publish lists of known malicious and safe resource identifiers and the entity providing or controlling threat detection system 102 may develop its own lists of resource identifiers corresponding to the classification categories such that these known resource identifiers can be provided to web crawler 114 to scan the resource identifiers. Scanning the resource identifiers may include scraping content from the web pages returned by servers 104a-104n responsive to the resource identifiers. For example, web crawler 114 may access a web page associated with a URL to collect HTML content of the webpage, webpage metadata, or other webpage data from or about the webpage returned responsive to the URL.

URLs may be sourced from multiple feeds, both benign and phishing, and are scraped using web crawler 114. Preferably, web crawler 114 allows the capture of content as it is dynamically loaded just as a user would see it. This can be beneficial for scraping phishing pages that rely on JavaScript to load content dynamically as a means of evading automated detection. According to one embodiment, multiple instances of web crawler 114 run on distributed nodes. To mitigate the ephemerality challenge, URLs may be scraped within minutes of being reported, thereby improving the chances of capturing a live phishing page before it goes offline.

As discussed above, a web-scraped dataset, such as web-scraped dataset 116, may include low quality data. Threat detection system 102 can thus include a data enhancement service 118 to remove low quality data to generate an enhanced web-scraped dataset 120 for training ML models. In the illustrated embodiment, data enhancement service 118 comprises several phases including initial filtering 121, prototype discovery stage 122, prototype inspection stage 124, nearest neighbor search stage 126, and sample removal stage 128. At a high level, data enhancement service 118 discovers representative data points (prototypes) corresponding to undesirable failure modes and eliminates entire groups of points/samples from web-scraped dataset 116 at a time to generate enhanced web-scraped dataset 120.

URLs are often reported to multiple feeds, URLs can be normalized to canonical form and data at the URL level. The canonicalization process includes, for example, removing trailing slashes and converting the URL to lowercase. At initial filtering stage 121, data is deduplicated at the URL level. Further, webpage HTML can be parsed and the title of the pages extracted. Pages with titles containing certain keywords such as “forbidden” or “not found” are removed as they are likely to be scrape failures.

Prototype discovery stage 122 groups the samples from web-scraped dataset 116 (e.g., as filtered by initial filtering stage 121) into groups of similar samples. At prototype inspection stage 124, prototypes are selected from the groups and inspected to identify prototypes to be removed from the web-scraped dataset 116. For example, prototypes representing web-scraping failure modes, such as those discussed above, can be identified for removal.

This evaluation process may be a human-in-the-loop process in which data enhancement service 118 provides the selected prototypes to a human evaluator (e.g., a user of evaluator computer 107) for review. Based on interaction with a graphic user interface or other interface provided at evaluator computer 107, the human evaluator can indicate whether to keep or reject prototypes for the enhanced dataset. Thus, data enhancement service 118 can receive an input indicating whether a prototype is rejected.

In addition, or in the alternative, data enhancement service 118 applies an evaluation model 125 to the prototypes to classify the prototypes for removal/non-removal. Evaluation model 125 may be a rule-based model or a machine learning model, such as a neural network, that is trained using samples to categorize new samples based on quality. For example, evaluation model 125, according to one embodiment, is an ML model trained using low quality samples and high-quality samples to categorize prototypes according to corresponding categories, such as “keep” and “reject.” Thus, when evaluation model 125 is applied to a prototype, evaluation model 125 can categorize the prototype as “keep” or “reject.”

A budget may be imposed to limit the number of prototypes evaluated when enhancing a dataset. In embodiments that include human-in-the-loop evaluations and an evaluation model, budgets may be imposed on the human-in-the-loop evaluations and the model-based evaluations. In another example embodiment, a budget is imposed on human-in-the loop evaluations, but additional evaluations may be performed using an evaluation model (e.g., evaluation model 125). Other budget schemes may also be used.

Near neighbor search stage 126 identifies other samples from web-scraped dataset 116 that are sufficiently similar to the rejected prototypes to be selected for removal. These samples may also be rejected from inclusion in enhanced dataset 120. Various methods for determining near-neighbor samples may be used. One embodiment of an efficient near-neighbor search uses locality-sensitive hashing. In another embodiment, a linear search is performed to find the near neighbor samples near to a rejected prototype. In some embodiments, a multi-level search is performed.

At sample removal stage 128, the rejected prototypes and nearest neighbor samples are removed from web-scraped dataset 116 to create enhanced web-scraped dataset 120. Enhanced dataset 120 can be input to an ML training stage 130 to train/retrain one or more ML models (e.g., ML model 112) used for threat detection.

In the embodiment of FIG. 1, threat detection is performed at one or more servers, such as in a cloud-based system. In other embodiments, as shown in more detail below, threat detection can be integrated into client devices (e.g., client device 106a, client device 106b, client device 106c). By way of example, but not limitation, one or more clients may include a threat detection engine 110 such that threats can be detected at the client device. Enhanced dataset 120 can be used to train an ML model 125 used by the threat detection engine of the client device. For example, enhanced dataset 120 may be used to train an ML model of a cloud-based threat detection service that is used by the threat detection engines of the client devices or to train ML models deployed to the client devices.

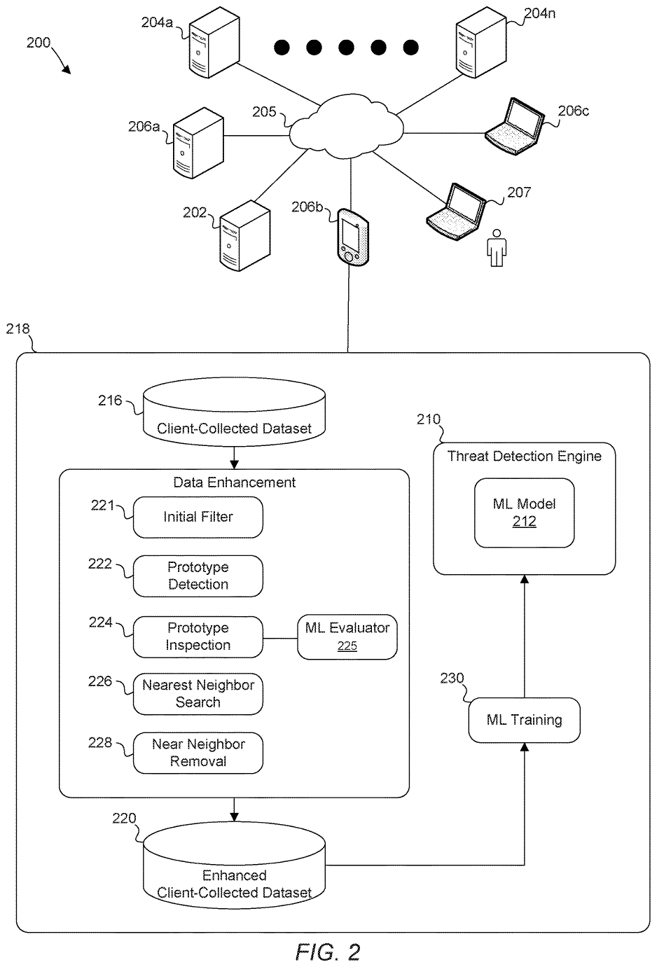

FIG. 2 is a diagrammatic representation of another embodiment of a system 200 for protecting computers from malicious content in which the client itself the webpage and sends the HTML (or a feature vector derived therefrom) to the backend for scoring, bypassing the central scraping system.

System 200 comprises a threat detection server 202 coupled to various web site servers (e.g., server 204a through 204n), threat detection client computers (e.g., client computer 206a, client computer 206b, client computer 206c are illustrated) and reviewer computers (e.g., reviewer computer 207), which may also be threat detection client computers, via network 205, which may include a combination of networks. Network 205 may include local area networks, wide area networks, such as the Internet, or other networks.

According to this embodiment, ML model 212 may be trained to classify webpages as “phishing” or “benign.” ML model 212 may be a predictive or statistical machine learning component that may be used to determine a probability distribution over one or more character sequences, classes, objects, result sets or events, and/or to predict a response value from one or more predictors. In some embodiments, ML model 212 comprises a neural network. ML model 212 can comprise multiple models working as an ensemble using multiple detection approaches.

In one embodiment, threat detection client device 206b accesses data referenced by identifiers, such as resource identifiers (e.g., URLs), for evaluation by threat detection system 202. In aspects, client device 206b access the content contained on web pages (or other resources) associated with the resource identifiers (e.g., URLs). The client device 206b then assemble or package the content as a client-collected dataset 216.

In some embodiments, client-collected dataset 216 includes one or more data structures containing the HTML code of the content referenced by the URLs. Alternatively or additionally, the client device 206b may encode at least a portion of the URL content as one or more feature vectors and package the feature vectors in the client-collected dataset 216.

In some embodiments, client device 206b encodes the unstructured content (e.g. HTML data) based on the frequency and presence of specific HTML tags used in phishing attacks. Phishing websites may use a large number of form inputs or other user-facing inputs when compared to the total HTML content of the webpage. Phishing websites may also turn off auto-complete or use hidden tags to hide their malicious activity. Client device 206b may generate a feature vector for the respective URL, where the feature vector is an array representing the weighting of the tags in the HTML code of the one or more webpages referenced by the URL. In some embodiments, the feature vector comprises indices representing the frequency of the tags in the HTML code (e.g. a count of forms, count of password fields, ratio of forms to content).

In other embodiments, client device 206b encode the unstructured content (e.g. HTML data) based on the structure of the webpage itself (e.g. using the HTML structure as a tree). The tags of the webpage are extracted from the webpage to create a hierarchy or tree of the webpage. One or more feature vectors representing the webpage structure are generated and included in the client dataset 216.

The client device 206b transmits the client-collected dataset 216 to threat detection server 202. Threat detection engine 210 on the threat detection server 202 determines if a provided resource identifier represents a malicious webpage. Threat detection engine 210 on the server uses ML model 212 to evaluate the client-collected dataset 216 and classify the resource identifiers (e.g., URLs) into categories (e.g., phishing, benign, etc.). The scoring performed by threat detection engine 210 and ML model 212 is substantially as described with respect to FIG. 1. If a resource identifier is classified as malicious (e.g., “phishing”), threat detection engine 210 may take remedial action, such as sending a message to the client computer to block downloading of a resource, sending a hyperlink referencing a security patch for securing the vulnerabilities exploitable by the malicious URL, etc.

ML model 212 of FIG. 2 may be trained on a dataset that includes content scraped from web pages by client device 206b. To this end, threat detection system 202 is provided with a client-collected dataset 216 in which the samples (data points) represent webpages belonging to the categories on which ML model 212 is to be trained. Each sample (data point) may represent a corresponding webpage instance and include webpage data from or about the corresponding webpage, including HTML scraped from the webpage. A sample may also include webpage metadata or other information from or about the corresponding webpage. In an even more particular embodiment, each data point comprises a string containing HTML content scraped from a corresponding webpage. In some embodiments, the samples in the web dataset are represented as corresponding records or vectors encoding features in a format suitable for processing by a computer. Client-collected dataset 216 may include tens-of-thousands or more (e.g., hundreds of thousands or millions) samples accessed by client devices 206a-206c. In one embodiment, client-collected dataset 216 includes collected data for over one hundred thousand phishing pages and over two hundred thousand benign pages.

In some cases, a portion of client-collected dataset 216 may be provided by a third party. For example, commercial and volunteer threat detection providers publish web-scraped datasets. Scanning the resource identifiers by the client devices 206a-206c may include accessing content from the web pages returned by servers 204a-204n responsive to the resource identifiers. For example, client devices 206a-206c may access a web page associated with a URL to collect HTML content of the webpage, webpage metadata, or other webpage data from or about the webpage returned responsive to the URL.

URLs may be sourced from multiple feeds, both benign and phishing, and are scraped using client devices 206a-206c. Preferably, client devices 206a-206c allows the capture of content as it is dynamically loaded just as a user would see it. This can be beneficial for scraping phishing pages that rely on JavaScript to load content dynamically as a means of evading automated detection. According to one embodiment, client devices 206a-206c act as distributed nodes. To mitigate the ephemerality challenge, URLs may be accessed and processed by clients within minutes of being reported, thereby improving the chances of capturing a live phishing page before it goes offline.

Client-collected dataset 216 may include low quality data. Threat detection server 202 can thus include a data enhancement service 218 to remove low quality data to generate an enhanced client-collected dataset 220 for training ML models. In the illustrated embodiment, data enhancement service 218 comprises several phases including initial filtering 221, prototype discovery stage 222, prototype inspection stage 224, nearest neighbor search stage 226, and sample removal stage 228. At a high level, data enhancement service 218 discovers representative data points (prototypes) corresponding to undesirable failure modes and eliminates entire groups of points/samples from client-collected dataset 216 at a time to generate enhanced client-collected dataset 220.

URLs are often reported to multiple feeds, URLs can be normalized to canonical form and data at the URL level. The canonicalization process includes, for example, removing trailing slashes and converting the URL to lowercase. At initial filtering stage 221, data is deduplicated at the URL level. Further, webpage HTML can be parsed and the title of the pages extracted. Pages with titles containing certain keywords such as “forbidden” or “not found” are removed as they are likely to be scrape failures.

Prototype discovery stage 222 groups the samples from client collected dataset 216 (e.g., as filtered by initial filtering stage 221) into groups of similar samples. At prototype inspection stage 224, prototypes are selected from the groups and inspected to identify prototypes to be removed from the web-scraped dataset 216. For example, prototypes representing web-scraping failure modes, such as those discussed above, can be identified for removal.

This evaluation process may be a human-in-the-loop process in which data enhancement service 218 provides the selected prototypes to a human evaluator. Based on interaction with a graphic user interface or other interface provided at evaluator computer 207 or client devices 206a-206c, the human evaluator can indicate whether to keep or reject prototypes for the enhanced dataset. Thus, data enhancement service 218 can receive an input indicating whether a prototype is rejected.

In addition, or in the alternative, data enhancement service 218 applies an evaluation model 225 to the prototypes to classify the prototypes for removal/non-removal. ML Evaluator model 225 may be a rule-based model or a machine learning model, such as a neural network, that is trained using samples to categorize new samples based on quality. For example, evaluation model 225, according to one embodiment, is an ML model trained using low quality samples and high-quality samples to categorize prototypes according to corresponding categories, such as “keep” and “reject.” Thus, when evaluation model 225 is applied to a prototype, evaluation model 225 can categorize the prototype as “keep” or “reject.”

A budget may be imposed to limit the number of prototypes evaluated when enhancing a dataset. In embodiments that include human-in-the-loop evaluations and an evaluation model, budgets may be imposed on the human-in-the-loop evaluations and the model-based evaluations. In another example embodiment, a budget is imposed on human-in-the loop evaluations, but additional evaluations may be performed using an evaluation model (e.g., evaluation model 225). Other budget schemes may also be used.

Near neighbor search stage 226 identifies other samples from client-collected dataset 216 that are sufficiently similar to the rejected prototypes to be selected for removal. These samples may also be rejected from inclusion in enhanced dataset 220. Various methods for determining near-neighbor samples may be used. One embodiment of an efficient near-neighbor search uses locality-sensitive hashing. In another embodiment, a linear search is performed to find the near neighbor samples near to a rejected prototype. In some embodiments, a multi-level search is performed.

At sample removal stage 228, the rejected prototypes and nearest neighbor samples are removed from client-collected dataset 216 to create enhanced client-collected dataset 220. Enhanced client-collected dataset 220 can be input into an ML training stage 230 to train/retrain one or more ML models (e.g., ML model 212) used for threat detection.

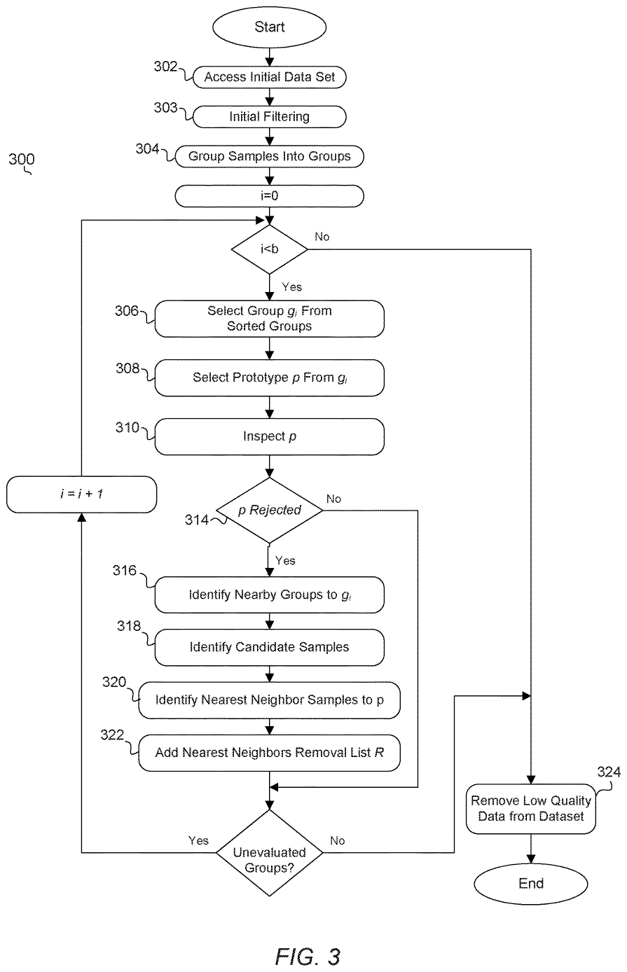

FIG. 3 is a flowchart illustrating one embodiment of a method 300 for enhancing data quality. One or more steps of method 300 may be embodied as computer-translatable instructions stored on a non-transitory, computer-readable medium. One or more steps of method 300 may be performed by a system used to train ML models or provide training data for training ML models. One or more steps of method 300, may be performed by a data enhancement application or service, such as data enhancement service 118.

At step 302, an initial dataset comprising representative samples for target categories is collected or accessed. For example, threat detection system 102 accesses web-scraped dataset 116 in which the samples (data points) represent webpages belonging to the categories on which ML model 112 is to be trained.

At step 303, initial filtering may be performed. For example, duplicate webpages and webpages meeting initial filtering criteria, such as pages having titles that match keywords, may be removed.

At step 304, the samples from the web dataset are grouped into groups (e.g., buckets, bins, clusters or other groups) of similar examples. For example, prototype discovery stage 122 groups the samples from web-scraped dataset 116 (as cleaned at step 303) into groups of similar samples where the similar samples have similar webpage content. A number of techniques can be used to form groups, such as clustering (e.g., k-means, hierarchical clustering, or other clustering), fuzzy hashing, or anomaly detection. Samples may also be grouped together using various heuristics and/or characteristics of the data points, such as page title, domain name, HTML content or other features.

According to one embodiment, the samples from the initial dataset are encoded in a metric space in which a distance function (or metric) is defined on the data points. The metric space and distance function can depend on the type of data. In some embodiments, the webpage content of a sample is expressed as a string of HTML content scraped from a corresponding webpage. Examples of distance functions in string-space include a variety of edit distances such as the Levenstein distance or Hamming distance. String data may also be encoded numerically by constructing a real-valued vector containing n-gram counts, term frequency-inverse document frequency (TF-IDF) features, or learned embeddings. In one embodiment, for example, each sample is encoded as a TF-IDF vector. In numeric space, any one of many different distance functions may be used, such as the Euclidean distance or cosine distance.

Thus, samples are organized into groups where group membership is determined by the chosen distance metric. Two points belonging to the same group are said to be similar with respect to the distance metric. Groups may be formed using clustering methods such as k-means or hierarchical clustering or using fuzzy hashing methods such as locality-sensitive hashing.

According to one embodiment, locality-sensitive hashing (LSH) is used to partition samples from the initial dataset, such as web-scraped dataset 116, into groups. LSH is an efficient method for grouping similar items into the same “bucket” with high probability. Not only are items within a bucket (group) likely to be similar to one another (these are known as “good” collisions), “nearby” buckets are also likely to contain items that are similar to items in buckets nearby.

According to one embodiment, TF-IDF vectors are generated representing data points from the initial dataset and the data points are grouped by performing LSH via random projection. In some embodiments, multiple groupings are performed. For example, a second grouping may be performed with respect to page titles, domain names, or other features of the sample web pages.

An iterative process is performed to evaluate prototypes from the groups to identify low quality data. In the embodiment of FIG. 3, a budget b is imposed to limit the number of prototypes evaluated when enhancing a dataset. A determination that a prototype represents low quality data can be applied to nearest neighbor samples in bulk. According to one embodiment, the prototypes are evaluated starting with the largest group. Due to the nature of webpage scraping, the largest groups tend to correspond to the failure modes. For example, page takedown notices are very common when attempting to scrape phishing pages. By starting with the largest groups, embodiments of the present disclosure can quickly address the most common failure modes encountered in web scraping.

At step 306, a group g is selected from the groups determined from step 304. As discussed, the groups may be sorted based on size such that the largest group is evaluated first.

At step 308, a representative sample (prototype) p is selected from group g. For example, data enhancement service 118, at prototype inspection stage 124, selects a prototype from a group output by prototype discovery stage 122. The prototype for a group may be chosen via simple random sampling, choosing the group “average member” or according to another selection scheme. In cases where clustering is used for group formation, the centroid of the cluster can be determined and the member sample that is closest to the centroid can be selected as the “average member” of the group. Likewise, in cases where fuzzy hashing forms the basis for groups, the centroid of a bin can be calculated from all the members within the group and the member sample closest to the centroid selected as the “average member.” As another example, the group medoid can be selected as the prototype for the group.

At step 310, the prototype is provided to an evaluator to assess the quality of the prototype and a decision to keep or reject each prototype is returned. If the prototype p is rejected, the prototype may be added to a list R of low-quality data samples.

For example, in one embodiment, data enhancement service 118 provides the selected prototype to a human evaluator (e.g., a user of evaluator computer 107) for review. Based on interaction with a graphic user interface or other interface provided at evaluator computer 107, data enhancement service 118 receives an indication of whether the prototype is accepted for or rejected from inclusion in the enhanced dataset. Quality may be determined, for example, by inspecting the HTML content, viewing a screenshot of the page or otherwise inspecting the prototype to determine whether the data point (i.e., the selected prototype) belongs to one of the failure modes previously discussed. In another embodiment, an evaluation model is applied to the prototype to keep or reject the prototype. For example, data enhancement service 118 may apply an evaluation model 125 to the prototypes to classify the prototypes for removal/non-removal.

Having determined that a prototype p is rejected, other samples that are similar to the rejected prototype can also be identified for removal. According to one embodiment, a near neighbor search is performed to identify other samples, if any, that are similar to the rejected prototype. Various methods for determining near-neighbor samples may be used. One embodiment of an efficient near-neighbor search uses locality-sensitive hashing. In another embodiment, a linear search is performed to find the near neighbor samples near to a rejected prototype.

In some embodiments, a multi-level search is performed. At step 316, nearby groups that are near the rejected prototype's group are identified using, for example, LSH. In one embodiment, the groups that have a Hamming distance less than a threshold h from the rejected prototype's group are identified as nearby groups to the rejected prototype. That is, if prototype p belongs to group g, the nearby groups are found via HammingDistance(g, h)={g₀, g₁, . . . , gₖ} which are groups within hamming distance h. The number of nearby buckets grows exponentially with h so, in some embodiments, h may be restricted to a small value such as h≤3.

With LSH, each group or bin is specified by a bit vector and neighboring groups to a reference group (e.g., the group from which prototype p was selected) can be determined by computing bit vectors up to a certain Hamming distance from the bit vector of the reference group. If grouping is performed using other methods, other techniques can be used to determine nearby groups, e.g., average distance between group elements, distance between representative group elements, etc.

At step 318, the other members of the rejected prototype's group and the members of the nearby groups—that is, the members of the groups identified at step 316—are returned as a list of candidate samples for rejection.

At step 320, the similarity of each of the candidate samples to the rejected prototype p is determined. Candidate samples that are sufficiently similar to the rejected prototype p are identified as bad samples to be removed from the web dataset. According to one embodiment, the cosine distance between the rejected prototype p and each candidate sample from step 318 is determined. Because the number of samples retrieved at step 318 is much smaller than the web dataset overall, the cosine similarity can be efficiently determined. A cosine similarity threshold t can be used to eliminate erroneous “bad” collision data points so that only true near neighbors are identified as bad samples. For example, candidate samples that have a cosine distance of less than t from the rejected prototype p are identified as nearest neighbors and therefore low-quality data. At step 322 the nearest neighbors from step 320 are added to the removal list R.

This process of evaluating prototypes can be repeated until the budget b is exhausted or there are no remaining groups to evaluate. At step 324, the low-quality data is removed from the web dataset. For example, the data points listed in removal list R are removed from the web dataset.

FIG. 3 is merely an illustrative example, and the disclosed subject matter is not limited to the ordering or number of steps illustrated. Embodiments may implement additional steps or alternative steps, omit steps, or repeat steps.

In another embodiment, anomaly detection methods can also be used to group samples, together with the clustering methods described above (step 304). This may be especially useful in cases of problematic data points that form a small fraction of the overall data set. Any of the anomaly detection methods, such as isolation forest, local outlier factor (LOF), etc., can be used to produce a ranked list of anomalies. Out of these the top-k can be selected as prototypes to be inspected.

In other example embodiments, all the other members of the group from which a rejected prototype was selected are also rejected (selected for removal) without further determining the similarity between the members and the rejected prototype (e.g., without performing step 320 with respect to other members of the group of which the rejected prototype is a member). In addition, or in the alternative, when a group is identified as a nearby group with respect to a rejected prototype p (e.g., at step 316), all the members of that group are also rejected (selected for removal) without further determining the similarity between the members of the nearby group and the rejected prototype (e.g., without performing step 320 with respect to other members of the group of which the rejected prototype is a member).

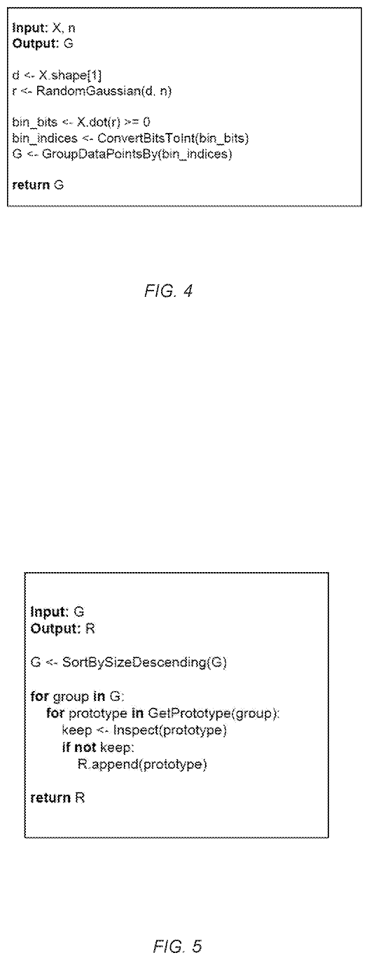

FIG. 4 illustrates pseudocode for performing one embodiment of LSH to group samples (e.g., step 304). In the embodiment of FIG. 4, data points x as encoded (e.g., as TF-IDF vectors or according to another encoding scheme) are hashed into buckets by computing the sign of the dot product between data points and n random Gaussian hyperplanes r∈ [symbol] ^{d×n}. That is, h(x)=sgn(x·r)∈ [symbol] 1ⁿ, where:
X∈ [symbol] ^{m×d}: dataset with m data points, each of dimension d.
n: Number of random projections.
G: list of subsets of data points, where each subset is a group assigned by LSH.

FIG. 5 illustrates one embodiment of pseudocode for prototype inspection stage 124 where: G is a list of subsets of data points, where each subset is a grouping assigned by LSH; R is a list of rejected prototypes to be removed from the web dataset; SortBySizeDescending(G) sorts the groups based on size (step 306); GetPrototype implements the prototype selection to select the prototypes from the groups (step 308); and Inspect provides the prototype to an evaluator (e.g., a human evaluator or model depending on implementation) and receives an indication of whether to keep or reject the prototype (step 310). If the evaluator indicates that the prototype should not be kept, the prototype is added to a list R of rejected prototypes. Because the groups are sorted based on descending size, the list R is also sorted based on descending size order of the prototype source groups (that is, in descending size order based on the size of the groups from which the rejected prototypes were selected).

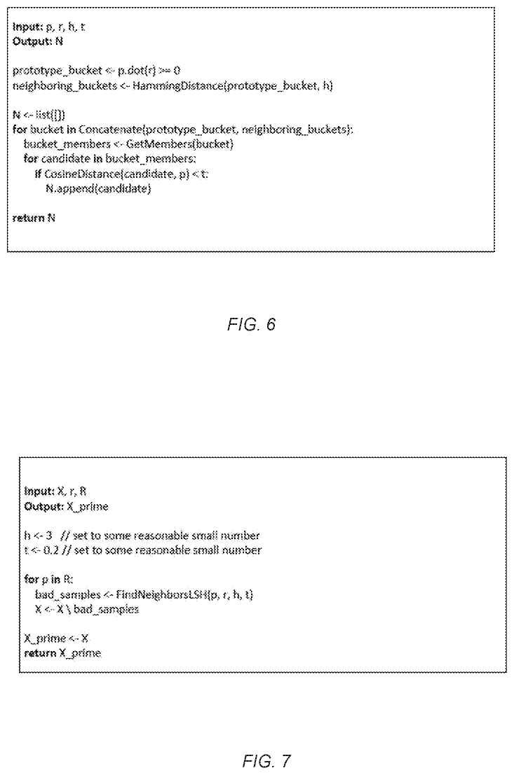

FIG. 6 illustrates one embodiment of pseudocode for performing an efficient near neighbor search where:
p∈ [symbol] ^{d}: a prototype data point.
r∈ [symbol] ^{d×n}: random projection vectors.
h∈ [symbol] : Hamming distance threshold.
t∈(0, 1): Cosine similarity threshold.
N: List of nearest neighbors.

The embodiment of FIG. 6 hashes p, identifies other buckets (groups) that are nearby to the prototype bucket in Hamming space, iterates over the prototype bucket and the nearby buckets to compute, for each sample in the prototype bucket and nearby buckets, the cosine distance to p, and, if the distance is below the threshold t for a candidate sample, adds the candidate to the list N of nearest neighbors.

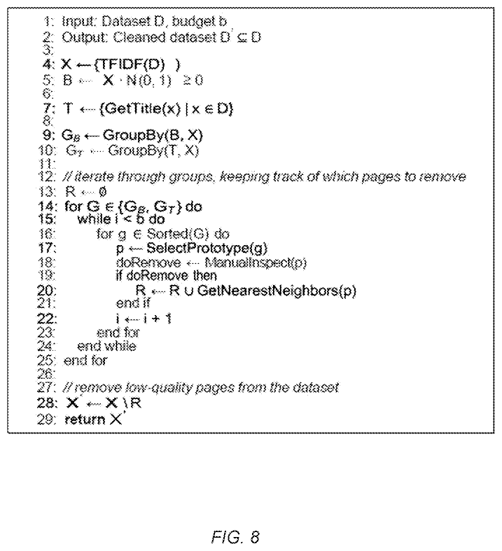

FIG. 7 illustrates one embodiment of pseudocode for removing samples from the web dataset, where:
X∈ [symbol] ^{m×d}: dataset with m data points, each of dimension d.
r∈ [symbol] ^{d×n}: random projection vectors.
R: list of rejected prototypes to be removed from the web dataset.
X′∈ [symbol] ^{m×d}: enhanced dataset.

The embodiment of FIG. 7 removes data from an original dataset X (e.g., from initial web-scraped dataset 116). The embodiment of FIG. 7 iterates over rejected prototypes p in R. FindNeighborsLSH finds samples in X that are within h Hamming distance of p's hash and within distance t of p.

FIG. 8 illustrates pseudocode for another example embodiment. In FIG. 8, a dataset D is enhanced to create an enhanced dataset D′, which is a subset of D. According to the embodiment of FIG. 8, TF-IDF vectors are generated for each data point (sample webpage) in D, wherein X is the set of feature vectors representing the data points. X is multiplied by a random Gaussian matrix (random projection), forming a representation, B, that can be used for grouping. Further, the titles of the webpages are extracted to generate T. A set of groups GB is determined by grouping the datapoints based on their random project values. A set of groups GT is determined by grouping the data points based on the titles. A removal set R is initialized, where R stores a list of data points marked for removal.

The embodiment of FIG. 8 loops over the groups determined using the grouping strategies. A group g is selected from the sorted groups (e.g., sorted by size), a prototype p is selected from the group, and the prototype p is provided to an evaluator for inspection. If the prototype p is deemed to be low-quality, the nearest neighbor samples to p are determined. As discussed above, this can be a multistep process of determining nearby groups to g and determining the similarity of members of the group to p. The nearest neighbors are added to the removal set R. The process of evaluating prototypes can be repeated until the budget b is exhausted. The samples from R are removed from the web dataset and an enhanced dataset D′ is returned.

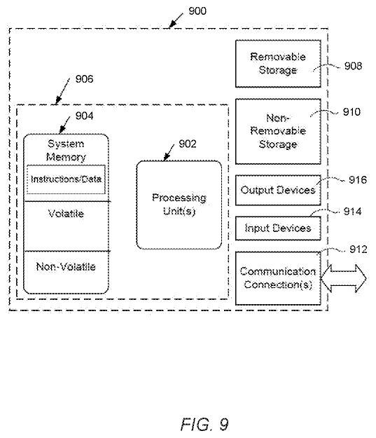

FIG. 9 illustrates one example of a suitable operating environment 900 in which one or more of the present embodiments may be implemented. This is only one example of a suitable operating environment and is not intended to suggest any limitation as to the scope of use or functionality. Other computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 900 typically includes at least one processing unit 902 and memory 904. Depending on the exact configuration and type of computing device, memory 904 (storing, among other things, resource identifiers, classification data, instructions to perform the methods disclosed herein, etc.) may be volatile (such as RAM), non-volatile (such as ROM, flash memory, etc.), or some combination of the two. This most basic configuration is illustrated in FIG. 9 by dashed line 906. Further, environment 900 may also include storage devices (removable, 908, and/or non-removable, 910) including, but not limited to, magnetic or optical disks or tape. Similarly, environment 900 may also have input device(s) 914 such as keyboard, mouse, pen, voice input, etc. and/or output device(s) 916 such as a display, speakers, printer, etc. Also included in the environment may be one or more communication connections, 912, such as LAN, WAN, point to point, etc.

Operating environment 900 typically includes at least some form of computer readable media. Computer readable media can be any available media that can be accessed by processing unit 902 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 900 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

In this disclosure, specific embodiments have been described with reference to the accompanying figures. In the above description, numerous details are set forth as examples. It will be understood by those skilled in the art, and having the benefit of this Detailed Description, that one or more embodiments described herein may be practiced without these specific details and that numerous variations or modifications may be possible without departing from the scope of the embodiments. Certain details known to those of ordinary skill in the art may be omitted to avoid obscuring the description.

In the above description of the figures, any component described with regard to a figure, in various embodiments, may be equivalent to one or more like-named components shown and/or described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

While embodiments described herein have been described with respect to a limited number of embodiments, those skilled in the art, having the benefit of this Detailed Description, will appreciate that other embodiments can be devised which do not depart from the scope of embodiments as disclosed herein.

What is claimed is:

1. A computer-implemented method for enhancing the quality of a dataset for training a machine learning model, the method comprising:
accessing a web dataset comprising a plurality of samples;
grouping the plurality of samples into a plurality of groups of similar samples using a grouping technique;
sorting the plurality of groups in descending order according to group size;
processing one or more of the sorted groups in order and subject to a budget constraint that limits the number of prototype evaluations, by repeatedly performing the following steps until the budget is exhausted or no groups remain:
selecting a prototype sample from the group;
evaluating the prototype sample using an evaluator to determine whether the prototype sample represents low-quality data; and
responsive to a determination that the prototype sample represents low-quality data:
identifying nearest neighbor samples to the prototype sample;
adding the prototype sample and the identified nearest neighbor samples to a removal list; and
generating an enhanced dataset for training by removing, from the accessed dataset, the samples contained in the removal list.

2. The method of claim 1, wherein the web dataset is a web-scraped dataset comprising HTML content scraped from a plurality of webpages.

3. The method of claim 1, wherein the grouping technique comprises locality-sensitive hashing.

4. The method of claim 3, wherein the grouping technique further comprises applying locality-sensitive hashing to TF-IDF feature vectors derived from the HTML content of the samples.

5. The method of claim 1, wherein the evaluator comprises a machine learning evaluation model.

6. The method of claim 1, wherein identifying nearest neighbor samples comprises performing a multi-level nearest neighbor search using locality-sensitive hashing buckets and a similarity threshold.

7. The method of claim 1, further comprising performing an initial filtering step on the web dataset prior to grouping the plurality of samples, the initial filtering step including at least one of URL-level deduplication or removal of samples based on predetermined webpage title keywords.

8. A system for enhancing the quality of a dataset for training a machine learning model, the system comprising:
one or more processors; and
a non-transitory computer-readable storage medium storing instructions that, when executed by the one or more processors, cause the system to perform operations comprising:
accessing a web dataset comprising a plurality of samples;
grouping the plurality of samples into a plurality of groups of similar samples using a grouping technique;
sorting the plurality of groups in descending order according to group size;
processing one or more of the sorted groups in order and subject to a budget constraint that limits the number of prototype evaluations, by repeatedly performing the following steps until the budget is exhausted or no groups remain:
selecting a prototype sample from the group;
evaluating the prototype sample using an evaluator to determine whether the prototype sample represents low-quality data; and
responsive to a determination that the prototype sample represents low-quality data:
identifying nearest neighbor samples to the prototype sample;
adding the prototype sample and the identified nearest neighbor samples to a removal list; and
generating an enhanced dataset for training by removing, from the accessed dataset, the samples contained in the removal list.

9. The system of claim 8, wherein the web dataset is a web-scraped dataset comprising HTML content scraped from a plurality of webpages.

10. The system of claim 8, wherein the grouping technique further comprises applying locality-sensitive hashing to feature vectors derived from the HTML content of the samples.

11. The system of claim 8, wherein the grouping technique further comprises applying locality-sensitive hashing to feature vectors derived from the HTML content of the samples.

12. The system of claim 8, wherein the evaluator comprises a machine learning evaluation model.

13. The system of claim 8, wherein identifying nearest neighbor samples comprises performing a multi-level nearest neighbor search using locality-sensitive hashing buckets and a similarity threshold.

14. The system of claim 8, further comprising performing an initial filtering step on the web dataset prior to grouping the plurality of samples, the initial filtering step including at least one of URL-level deduplication or removal of samples based on predetermined webpage title keywords.

15. A non-transitory computer-readable storage medium storing instructions that, when executed by one or more processors, cause the one or more processors to perform operations for enhancing the quality of a dataset for training a machine learning model, the operations comprising:
accessing a web dataset comprising a plurality of samples;
grouping the plurality of samples into a plurality of groups of similar samples using a grouping technique;
sorting the plurality of groups in descending order according to group size;
processing one or more of the sorted groups in order and subject to a budget constraint that limits the number of prototype evaluations, by repeatedly performing the following steps until the budget is exhausted or no groups remain:
selecting a prototype sample from the group;
evaluating the prototype sample using an evaluator to determine whether the prototype sample represents low-quality data; and
responsive to a determination that the prototype sample represents low-quality data:
identifying nearest neighbor samples to the prototype sample;
adding the prototype sample and the identified nearest neighbor samples to a removal list; and
generating an enhanced dataset for training by removing, from the accessed dataset, the samples contained in the removal list.

16. The non-transitory computer-readable storage medium of claim 15, wherein the web dataset is a web-scraped dataset comprising HTML content scraped from a plurality of webpages.

17. The non-transitory computer-readable storage medium of claim 15, wherein the grouping technique further comprises applying locality-sensitive hashing to feature vectors derived from the HTML content of the samples.

18. The non-transitory computer-readable storage medium of claim 15, wherein the operations further comprise performing a filtering of the web dataset prior to grouping the samples, the filtering including at least one of deduplication of samples or removal of samples based on predetermined criteria.

19. The non-transitory computer-readable storage medium of claim 15, wherein the evaluator comprises a machine learning evaluation model.

20. The non-transitory computer-readable storage medium of claim 15, wherein identifying nearest neighbor samples comprises performing a multi-level nearest neighbor search using locality-sensitive hashing buckets and a similarity threshold.
